(19) United States
(12) Patent Application Publication
(10) Pub. No.: US 2005/0276201 A1
(43) Pub. Date: Dec. 15, 2005

(54) Optical head device

(76) Inventor: Hiroshi Sakai, Suwa-gun (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/138,961

(22) Filed: May 25, 2005

(30) Foreign Application Priority Data
May 26, 2004 (JP) JP2004-15613

(51) Int. Cl. G11B 7/00; G11B 7/135

(52) U.S. Cl. 369/112.01; 369/112.29

(57) ABSTRACT

An optical head device including a semiconductor laser, a raising mirror for deflecting a laser beam emitted from the semiconductor laser to an optical recording disk, a light receiving element for monitor for monitoring the laser beam to control an output of the semiconductor laser. The major axis of an elliptical shaped optical spot which is converged on the optical recording disk is obliquely oriented with respect to both a radial direction of the optical recording disk and a tangential direction of a track of the optical recording disk, and the light receiving element for monitor is disposed behind the raising mirror to receive a light beam of an end part in a major axis direction of a far field pattern of the laser beam which is leaked over an edge side of the raising mirror.

### CROSS-REFERENCE TO RELATED APPLICATIONS

This application claims priority to Japanese Application No. 2004-156136 filed May 26, 2004, which is incorporated herein by reference.

### FIELD OF THE INVENTION

The present invention relates to an optical head device for performing recording and reproduction of information on and from an optical recording disk.

### BACKGROUND OF THE INVENTION

An optical head device for recording and reproduction of information on and from an optical recording disk, for example, a compact disk such as a CD and a CD-R, and a digital versatile disk such as a DVD and a DVD-R, is constructed such that a semiconductor laser 11, an optical system by which a laser beam “L” emitted from the semiconductor laser 11 is guided to an objective lens 30 and a return light beam from the optical recording disk 100 is guided to a light receiving element 43 for signal detection, and light receiving elements 40A, 40B for monitor that monitors the laser beam to control the output of the semiconductor laser 11 are respectively mounted on a frame which is moved in a radial direction of the optical recording disk 100 as shown in FIGS. 7 and 8. The optical system includes an optical path separating element 15 for separating a forward path directing to the optical recording disk 100 from the semiconductor laser 11 from a return path directing to the light receiving element 43 from the optical recording disk 100, a raising mirror 20A for deflecting the laser beam “L” emitted from the semiconductor laser 11 to the optical recording disk 100 (the direction of the objective lens 30) and the like.

The light receiving element for monitor is disposed to detect a component which is transmitted through a half mirror constructed as the raising mirror 20A as shown in FIG. 7, or to detect a component which is reflected by a polarizing beam splitter 15 as shown in FIG. 8.

However, as shown in FIGS. 7 and 8, in the construction for detecting the component which is transmitted through the half mirror as the raising mirror 20A or the component which is reflected by the polarizing beam splitter 15, a part of the laser beam “L” emitted from the laser beam emitting element 11 is required at some extent or more to be transmitted through the raising mirror 20A or reflected by the polarizing beam splitter 15. Therefore, from the viewpoint of the laser beam “L” which is guided to the optical recording disk 100, there is a problem that the loss of light quantity is large.

Also, in an optical head device, there is a technical problem that is described as follows. First, in order to cope with a high density recording on the optical recording disk 100 in the optical head device, the major axis of an optical spot in an elliptical shape that is converged on the optical recording disk 100 is preferably oriented in an oblique manner to both the radial direction of the optical recording disk 100 and the tangential direction of the track of the optical recording disk. The laser beam “L” emitted from the semiconductor laser 11 has an elliptical intensity distribution. When the elliptical laser beam “L” is converged on the optical recording disk 100 by using an objective lens 30 with a circular aperture, the spot shape becomes an elliptical shape. In this case, when the major axis of the elliptical shape is directed to the tangential direction of the track, the cross talk of signal with adjacent tracks becomes larger and recording/reproducing signal is deteriorated. Alternatively, when the major axis of the elliptical shape is directed to the radial direction of the optical recording disk 100, the size of narrowing down in the pit string direction for the light beam becomes larger and thus recording/reproducing signal is deteriorated.

Second, in order to attain a high-speed recording on the optical recording disk 100, an enhanced efficiency is required and thus a polarizing beam splitter 15 is preferably used as the optical path separating element. In this case, a ¼ wavelength phase difference plate 47 is disposed between the raising mirror 20A and the objective lens 30. Since the polarizing beam splitter 15 utilizes a polarization dependency, the variation of the double refractive index of the optical recording disk 100 that occurs in the radial direction based on the forming conditions of the disk may affect the polarization dependency. Therefore, to prevent this from happening, laser beam “L” is preferably set to be incident on the raising mirror 20A from the radial direction or the tangential direction of the track of the optical recording disk when the optical elements are laid out.

### SUMMARY OF THE INVENTION

In view of the problems described above, it is an object and advantage of the present invention to provide an optical head device which is capable of coping with a high density recording on an optical recording disk and monitoring the emitted light quantity of the laser beam without lowering the utilization efficiency of the laser beam that is used for recording and reproduction of information.

Further, it is another object and advantage of the present invention to provide an optical head device that is capable of attaining a high-speed recording on an optical recording disk.

In order to achieve the above object and advantage, according to an embodiment of the present invention, there is provided an optical head device including a semiconductor laser, a raising mirror for deflecting a laser beam which is emitted from the semiconductor laser to an optical recording disk, an objective lens for converging the laser beam deflected by the raising mirror on the optical recording disk, a light receiving element for signal detection for detecting a return light beam from the optical recording disk, an optical path splitting element for separating an optical path directing to the optical recording disk from the semiconductor laser from an optical path directing to the light receiving element for signal detection from the optical recording disk, and a light receiving element for monitor for monitoring the laser beam to control the output of the semiconductor laser. The major axis of an elliptical shaped optical spot which is converged on the optical recording disk is obliquely oriented with respect to both the radial direction of the optical recording disk and the tangential direction of the track of the optical recording disk, and the light receiving element for monitor is disposed behind the raising mirror to receive the light beam of an end part in the major axis direction of the far field pattern of the laser beam which is leaked over the edge side of the raising mirror.

In accordance with an embodiment of the present invention, the laser beam emitted from the semiconductor laser leaks in the rearward direction over the edge side of the raising mirror and the leaked light beam is received by the light receiving element for monitor. Therefore, the raising mirror is not required to be constructed by using a half mirror. Further, the light beam that is leaked over the edge side of the raising mirror is the light beam of the end part of the major axis direction of the far field pattern of the laser beam, which is a portion that is not used for the recording and reproduction of information. Therefore, the emitted light quantity of the laser beam can be monitored without lowering the utilization efficiency of the laser beam used for the recording and reproduction of information. Further, in the embodiment of the present invention, the major axis of an elliptical shaped optical spot which is converged on the optical recording disk is obliquely oriented with respect to both the radial direction of the optical recording disk and the tangential direction of the track of the optical recording disk. Therefore, the cross talk of signals with adjacent tracks can be improved in comparison with the case that the major axis of the elliptical shape is directed to the tangential direction of the track. In addition, the recording and reproducing signal is not deteriorated because the size of narrowing down in the pit string direction for the light beam is smaller in comparison with the case that the major axis of the elliptical shape is oriented in the radial direction of the optical recording disk.

In accordance with an embodiment of the present invention, a collimating lens may be provided for converting the laser beam that is transmitted through the optical path splitting element into a parallel light beam. In this case, the optical path splitting element and the collimating lens are disposed between the semiconductor laser and the raising mirror, and the light beam of the end part in the major axis direction of the far field pattern of the parallel laser beam emitted from the collimating lens and leaked over the edge side of the raising mirror is received by the light receiving element for monitor.

In accordance with an embodiment of the present invention, the optical path splitting element is preferably a polarizing separation splitter. In this case, a ¼ wavelength phase difference plate is disposed between the raising mirror and the objective lens. Therefore, the laser beam is preferably shown to be incident on the raising mirror from the radial direction or the tangential direction of the track of the optical recording disk. When a polarizing separation splitter is used as the optical path splitting element, the utilization efficiency of the light beam can be further enhanced and thus a further high-speed recording on the optical recording disk can be attained. In addition, the laser beam is set to be incident on the raising mirror from the radial direction or the tangential direction of the track of the optical recording disk at the time of the layout of the optical elements. Therefore, even when the utilization efficiency of the light beam is enhanced by utilizing the polarization of the laser beam, the affection of the variation of the double refractive index of the optical recording disk itself which occurs in the radial direction based on the forming conditions of the disk can be prevented.

In accordance with an embodiment of the present invention, it is preferable that the edge side of the raising mirror over which the laser beam leaks to be received by the light receiving element for monitor is linearly extended in the direction approximately perpendicular to the major axis of the far field pattern.

In order to obtain such construction, for example, a working C-face may be performed on the edge side of the raising mirror. Further, the raising mirror may be formed such that a planar shape of the raising mirror viewed from a normal direction to a reflection surface is rectangular, and the raising mirror may be obliquely disposed such that the edge part of one side of four sides of the raising mirror is set to be approximately perpendicular to the major axis of the far field pattern of the laser beam.

In accordance with an embodiment of the present invention, the edge side of the raising mirror over which the laser beam leaks to be received by the light receiving element for monitor is not limited to the straight line shape but may be formed in a circular arc shape. In this case, the edge side of the raising mirror over which the laser beam leaks to be received by the light receiving element for monitor is preferably formed in a shape which is approximately line symmetric with the major axis of the far field pattern.

According to the present invention, the laser beam emitted from the semiconductor laser leaks in the rearward direction over the edge side of the raising mirror and the leaked light beam is received by the light receiving element for monitor. Therefore, the raising mirror is not required to be constructed by using a half mirror. Further, the light beam which is leaked over the edge side of the raising mirror is the light beam of the end part of the major axis direction of the far field pattern of the laser beam, which is a portion that is not used for the recording and reproduction of information. Therefore, the emitted light quantity of the laser beam can be monitored without lowering the utilization efficiency of the laser beam that is used for the recording and reproduction of information. As a result, a high-speed recording on the optical recording disk can be attained. Further, in the present invention, the major axis of an elliptical shaped optical spot which is converged on the optical recording disk is obliquely oriented with respect to both the radial direction of the optical recording disk and the tangential direction of the track of the optical recording disk. Therefore, the cross talk of signals with adjacent tracks can be improved in comparison with the case that the major axis of the elliptical shape is directed to the tangential direction of the track. In addition, the recording and reproducing signal is not deteriorated because the size of narrowing down in the pit string direction for the light beam becomes smaller in comparison with the case that the major axis of the elliptical shape is oriented in the radial direction of the optical recording disk. Consequently, a high density recording on the optical recording disk can be performed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1(A) is a schematic construction view showing the optical system of an optical head device in accordance with an embodiment of the present invention and FIG. 1(B) is a schematic plan view showing the mounting structure of various optical elements to a frame.

FIG. 2 is an explanatory view showing the shape of a spot that is converged on an optical recording disk in the optical head device to which the present invention is applied.

FIG. 3 is an explanatory view showing a construction for monitoring a laser beam in the optical head device to which the present invention is applied.

FIG. 4(A) is an explanatory view showing the shape of a spot which is converged on an optical recording disk in the optical head device in accordance with a comparison example with the present invention and FIG. 4(B) is an explanatory view showing a construction for monitoring the laser beam in the optical head device in accordance with the comparison example.

FIG. 5 is an explanatory view showing a construction for monitoring a laser beam in the optical head device in accordance with another embodiment of the present invention.

FIG. 6 is an explanatory view showing a construction for monitoring a laser beam in the optical head device in accordance with another embodiment of the present invention.

FIG. 7 is a schematic construction view showing the optical system of a conventional optical head device.

FIG. 8 is a schematic construction view showing the optical system of another conventional optical head device.

### DETAILED DESCRIPTION OF THE PREFERRED EMBODIMENTS

The construction in accordance with embodiments of the present invention will be described below with reference to the accompanying drawings.

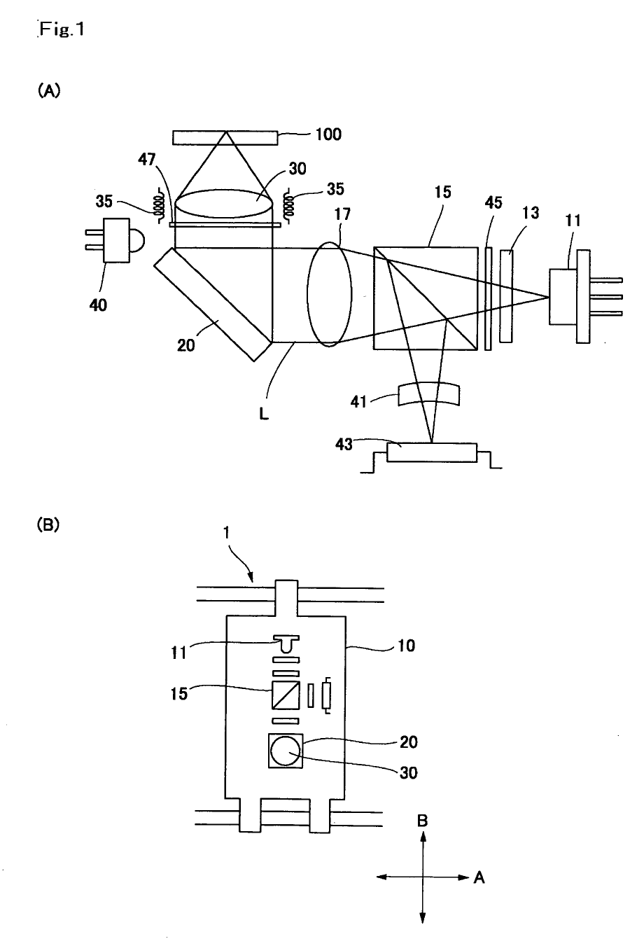

FIG. 1(A) is a schematic construction view showing the optical system of an optical head device to which the present invention is applied and FIG. 1(B) is a schematic plan view showing the mounting structure of various optical elements to a frame.

An optical head device 1 shown in FIG. 1(A) is used for the recording and reproduction of information on and from an optical recording disk, for example, a compact disk such as a CD, a CD-R, or a digital versatile disk such as a DVD, a DVD-R. The optical system of the optical head device 1 includes a laser beam emitting element or a semiconductor laser 11 as a light source, a grating 13 for dividing the laser beam emitted from the laser beam emitting element 11 into three beams, i.e., a zero-order light beam (main beam) and +first-order light beams (two sub-beams), a polarizing beam splitter (optical path splitting element) 15, a collimating lens 17 for converting the laser beam transmitted through the polarizing beam splitter 15 into a parallel light, a raising mirror 20 for deflecting the parallel light beam emitted from the collimating lens 17 in a predetermined direction, and an objective lens 30 for converging the parallel light beam deflected by the raising mirror 20 on the optical recording disk 100. These optical elements are disposed in this order, and an optical path (forward path) ranging from the laser beam emitting element 11 to the optical recording disk 100 is constructed.

A sensor lens 41 and a light receiving element 43 for signal detection are disposed on the side of the polarizing beam splitter 15. Therefore, the return light beam reflected by the optical recording disk 100 is made incident on the polarizing beam splitter 15 through the objective lens 30, the raising mirror 20 and the collimating lens 17 and bent in an orthogonal direction by the polarizing beam splitter 15 to be guided to the sensor lens 41 and the light receiving element 43 for signal detection. In this manner, an optical path (return path) of the return light beam ranging from the optical recording disk 100 to the light receiving element 43 for signal detection is constructed. The sensor lens 41 generates an astigmatism in the return light beam from the optical recording disk 1 and increases the magnifying power of the return light beam. A lens drive device 35 is constructed for driving the objective lens 30. However, a well-known construction can be utilized for the lens drive device 35 and thus its description is omitted.

In the optical head device 1 in accordance with the embodiment of the present invention, the polarizing beam splitter 15 is used as the optical path splitting element for splitting the forward path directing to the optical recording disk 100 from the semiconductor laser 11 from the return path directing to the light receiving element 43 for signal detection from the optical recording disk 100. Further, the ½ wavelength phase difference plate 45 is disposed between the grating 13 and the polarizing beam splitter 15, and the ¼ wavelength phase difference plate 47 is disposed between the raising mirror 20 and the objective lens 30. Therefore, for example, when a P-polarized light beam is emitted from the semiconductor laser 11, an S-polarized light beam is emitted from the polarizing beam splitter 15 by the ½ wavelength phase difference plate 45. The S-polarized light beam is changed into a circularly polarized light by the ¼ wavelength phase difference plate 47 and then converged on the optical recording disk 100 through the objective lens 30. Further, the laser beam reflected as the circularly polarized light beam by the optical recording disk 100 is incident on the polarizing beam splitter 15 as the P-polarized light beam by the ¼ wavelength phase difference plate 47 and guided to the light receiving element 43 for signal detection.

All optical elements are supported on the frame 10 that is moved in the radial direction “A” of the optical recording disk 100 as schematically shown in FIG. 1(B). In this embodiment, the respective optical elements are disposed such that the laser beam emitted from the semiconductor laser 11 is set to be incident on the raising mirror 20 from the tangential direction “B” of the track of the optical recording disk 100.

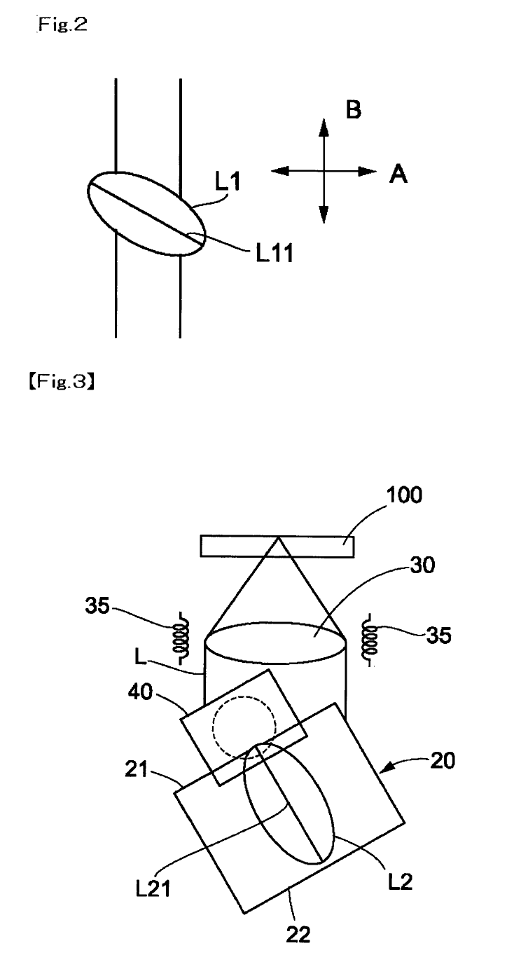

FIG. 2 is an explanatory view showing the shape of a spot that is converged on the optical recording disk in the optical head device to which the present invention is applied. FIG. 3 is an explanatory view showing a construction for monitoring a laser beam in the optical head device to which the present invention is applied.

In FIG. 1(A), in the optical head device 1 in accordance with the embodiment of the present invention, the laser beam “L” emitted from the semiconductor laser 11 has an intensity distribution in an elliptical shape. When the laser beam “L” is converged on the optical recording disk 100 through the objective lens 30 with a circular aperture, the spot “L1” becomes an elliptical shape as shown in FIG. 2. Therefore, in the embodiment of the present invention, the angular position of the semiconductor laser 11 around the optical axis of the emitted light beam is adjusted in a predetermined direction such that the major axis “L11” of the elliptical shaped spot “L1” converged on the optical recording disk 100 is oriented at angular position of obliquely 45° with respect to both the radial direction “A” of the optical recording disk 100 and the tangential direction “B” of the track of the optical recording disk 100.

As shown in FIG. 3, the raising mirror 20 is formed such that its planar shape is rectangular when its reflection surface is viewed from the normal direction. The raising mirror 20 is diagonally disposed such that its upper edge side 21 and lower edge side 22 are approximately orthogonal to the major axis “L21” of the far field pattern “L2” of the laser beam “L”. Further, in the state that the raising mirror 20 is diagonally arranged, the raising mirror 20 is disposed so that the light beam of an end part in the major axis “L2” direction of the far field pattern “L2” leaks over the upper edge side 21 (edge part) to the rear side. Therefore, in the embodiment of the present invention, the light receiving element 40 for monitor is disposed on the rear side of the raising mirror 20, and the light beam which leaks in the rearward direction over the upper edge side 21 of the raising mirror 20 is received and detected by the light receiving element 40 for monitor to control the output of the semiconductor laser 11.

As described above, in the optical head device 1 in accordance with the embodiment of the present invention, the laser beam “L” emitted from the semiconductor laser 11 leaks in the rearward direction from the upper edge side 21 of the raising mirror 20, and the light receiving element 40 for monitor receives the light beam which is leaked out. Therefore, the raising mirror 20 is not required to be constructed by using a half mirror. Further, the light beam that leaks over the upper edge side 21 of the raising mirror 20 is the light beam of the end part in the major axis “L21” direction of the far field pattern “L2” of the laser beam “L”, which is a portion that is not used for the recording and reproduction of information. Accordingly, the emitted light quantity of the laser beam “L” can be monitored without lowering the utilization efficiency of the laser beam “L” which is used for the recording and reproduction of information. As a result, a high-speed recording on the optical recording disk 100 can be attained.

In addition, the upper edge side 21 of the raising mirror 20, over which the laser beam “L” leaks to be received by the light receiving element 40 for monitor, linearly extends in the direction approximately perpendicular to the major axis “L21” of the far field pattern “L2”. Therefore, the upper edge side 21 is formed to be linearly symmetric with the major axis “L21” of the far field pattern “L2”. Accordingly, even when the emitted strength from the semiconductor laser 11 is varied or the intensity distribution of the laser beam “L” is varied, the linearity of signal which is detected by the light receiving element 40 for monitor can be ensured.

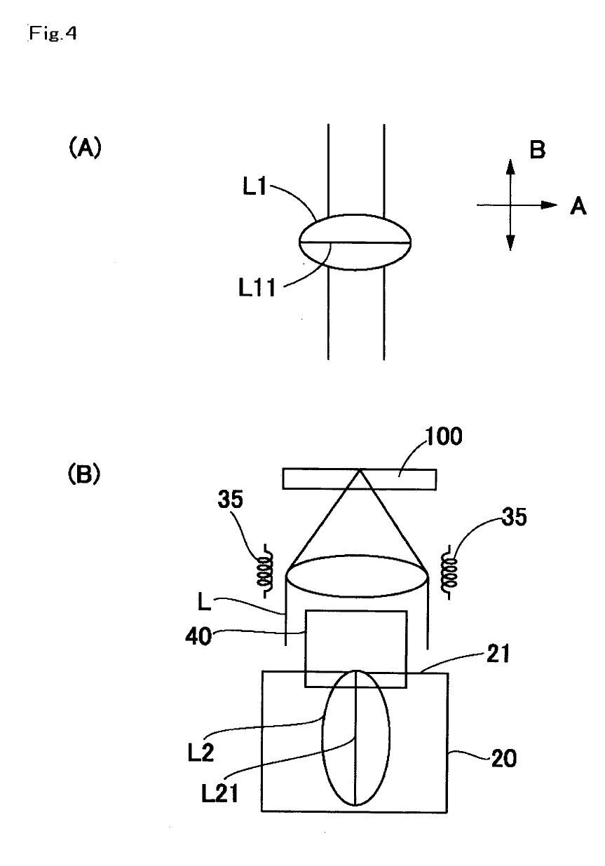

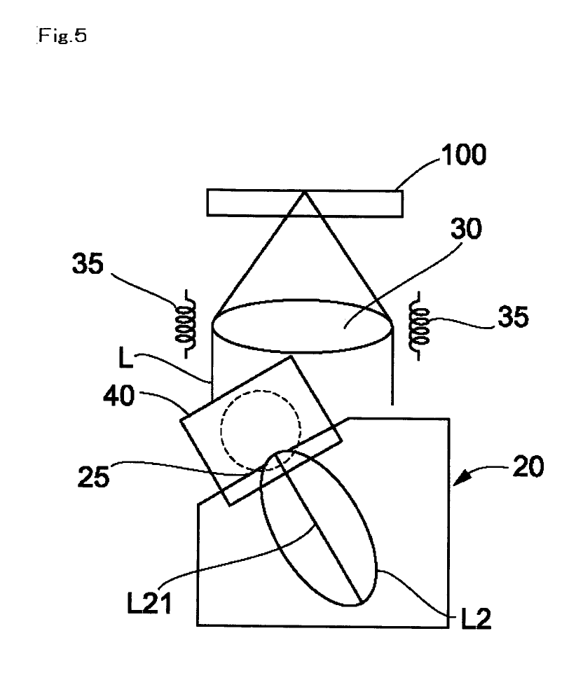

In the case that the major axis “L11” of an elliptical shaped spot “L1” which is converged on the optical recording disk 100 is disposed in parallel with the tangential direction “B” of the track of the optical recording disk 100 as shown in FIG. 4(A), it may be constructed so that a part of the laser beam “L” can leak over the upper edge side 21 by adjusting the size of the raising mirror 20 as shown in FIG. 4(B). However, in the embodiment of the present invention, the major axis “L11” of an elliptical shaped spot “L1” which is converged on the optical recording disk 100 is obliquely disposed and oriented with respect to both the radial direction “A” of the optical recording disk 100 and the tangential direction “B” of the track of the optical recording disk 100, and the raising mirror 20 is obliquely disposed to match with the major axis “L11”. Therefore, even when a rectangular raising mirror 20 is used, the upper edge side 21 of the raising mirror 20 where the laser beam “L” leaks to be received by the light receiving element 40 for monitor can be disposed so as to linearly extend in the direction approximately perpendicular to the major axis “L21” of the far field pattern “L2”.

Further, in the embodiment of the present invention, the major axis “L11” of the elliptical shaped spot “L1” converged on the optical recording disk 100 is oriented at angular position of obliquely 45° with respect to both the radial direction “A” of the optical recording disk 100 and the tangential direction “B” of the track of the optical recording disk 100. Therefore, the cross talk of signals with adjacent tracks can be improved in comparison with the case that the major axis “L11” of the elliptical shape is oriented to the tangential direction “B” of the track. In addition, a recording or reproducing signal is not deteriorated because the size of narrowing down in the pit string direction for the light beam becomes smaller in comparison with the case that the major axis “L11” of the elliptical shape is oriented in the radial direction “A” of the optical recording disk 100. Consequently, a high density recording on the optical recording disk 100 can be performed.

Furthermore, in the embodiment of the present invention, since the polarizing separation splitter 15 is used as the optical path splitting element, the utilization efficiency of the laser beam “L” can be further enhanced and thus a further high-speed recording on the optical recording disk 100 can be attained. In addition, the laser beam “L” is made incident to the raising mirror 20 from the tangential direction “B” of the track of the optical recording disk 100 in the layout of the optical elements and thus the delay phase axis of the ¼ wavelength phase difference plate 47 can be set at about 45°. Therefore, even when the utilization efficiency of the light beam is enhanced by utilizing the polarization of the laser beam “L”, the affection of the variation of the double refractive index of the optical recording disk 100 itself which occurs in the radial direction based on the forming conditions of the disk can be prevented.

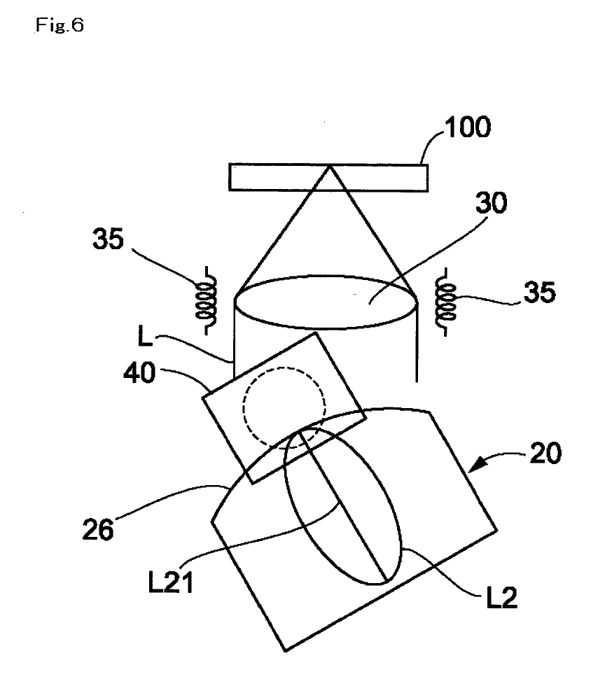

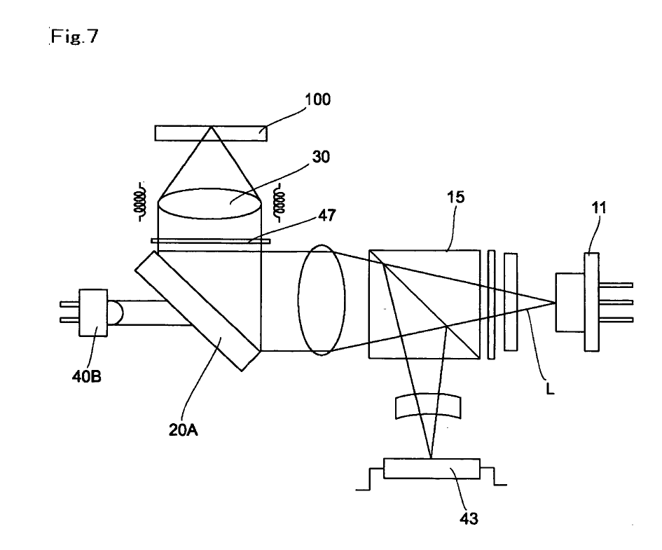

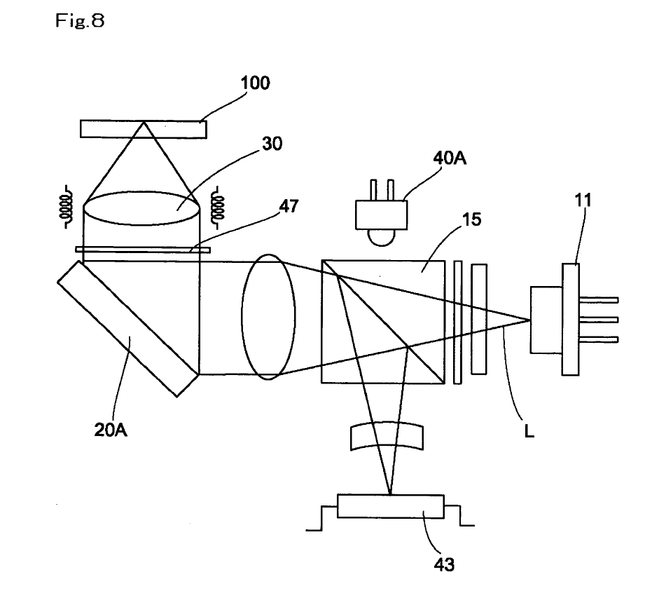

In the embodiment of the present invention, a rectangular mirror is used as the raising mirror 20 and the light beam of the end part in the direction of the major axis “L21” of the far field pattern “L2” of the laser beam L is guided to the light receiving element 40 for monitor through the upper edge side 21. However, the corner part of the rectangular raising mirror 20 is removed by a working C-face to form an oblique side 25 as shown in FIG. 5, and the light beam of the end part in the direction of the major axis “L21” of the far field pattern “L2” of the laser beam “L” may be guided to the light receiving element 40 for monitor through the oblique side 25.

Further, in the embodiment shown in FIGS. 3 and 4, the raising mirror 20 is disposed such that the edge side of the raising mirror 20, over which the laser beam “L” received by the light receiving element 40 for monitor leaks, linearly extends approximately perpendicular to the direction of the major axis “L21” of the far field pattern “L2”. However, as shown in FIG. 6, the edge side 26 of the raising mirror 20, over which the laser beam “L” received by the light receiving element 40 for monitor leaks, may be formed in a circular arc shape. Also in this case, when the edge side 26 is formed in the shape which is approximately line symmetric with the major axis “L21” of the far field pattern “L2”, the linearity of signal which is detected by the light receiving element 40 for monitor is ensured even though the intensity distribution of the laser beam “L” is varied at the time of changing of the emitted strength of the semiconductor laser 11.

Further, the embodiment of the present invention described above is constructed such that the laser beam emitted from the semiconductor laser 11 is set to be incident on the raising mirror 20 from the tangential direction “B” of the track of the optical recording disk 100. However, it may be constructed such that the laser beam emitted from the semiconductor laser 11 is made incident on the raising mirror 20 from the radial direction “A” of the optical recording disk 100 to prevent the affection of the variation of the double refractive index of the optical recording disk 100 itself which occurs in the radial direction based on the forming conditions of the disk.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An optical head device comprising:
a semiconductor laser;
a raising mirror for deflecting a laser beam which is emitted from the semiconductor laser to an optical recording disk;
an objective lens for converging the laser beam deflected by the raising mirror on the optical recording disk;
a light receiving element for signal detection for detecting a return light beam from the optical recording disk;
an optical path splitting element for separating an optical path directed to the optical recording disk from the semiconductor laser from an optical path directed to the light receiving element for signal detection from the optical recording disk; and
a light receiving element for monitor for monitoring the laser beam to control an output of the semiconductor laser;
wherein the major axis of an elliptical shaped optical spot which is converged on the optical recording disk is obliquely oriented with respect to both a radial direction of the optical recording disk and a tangential direction of a track of the optical recording disk, and
the light receiving element for monitor is disposed behind the raising mirror to receive a light beam of an end part in a major axis direction of a far field pattern of the laser beam that leaks over an edge side of the raising mirror.

2. The optical head device according to claim 1, further comprising
a ¼ wavelength phase difference plate which is disposed between the raising mirror and the objective lens,
wherein the optical path splitting element is a polarizing separation splitter, and the laser beam is set to be incident on the raising mirror from the radial direction or the tangential direction of the track of the optical recording disk.

3. The optical head device according to claim 1, wherein the edge side of the raising mirror over which the laser beam leaks to be received by the light receiving element for monitor is linearly extended in a direction approximately perpendicular to the major axis of the far field pattern.

4. The optical head device according to claim 3, wherein the raising mirror is formed such that a planar shape of the raising mirror viewed from a normal direction to a reflection surface is rectangular, and the raising mirror is obliquely disposed such that an edge part of one side of four sides of the raising mirror is set to be approximately perpendicular to the major axis of the far field pattern of the laser beam.

5. The optical head device according to claim 1, wherein the edge side of the raising mirror over which the laser beam leaks to be received by the light receiving element for monitor is formed in a shape which is approximately line symmetric with the major axis of the far field pattern.

6. The optical head device according to claim 1, further comprising
a collimating lens for converting a laser beam which transmits through the optical path splitting element into a parallel light beam,
wherein the optical path splitting element and the collimating lens are disposed between the semiconductor laser and the raising mirror, and
the light beam of the end part in the major axis direction of the far field pattern of the parallel laser beam which is emitted from the collimating lens and leaked over the edge side of the raising mirror is received by the light receiving element for monitor.

7. An optical head device comprising:
a semiconductor laser;
a raising mirror for deflecting a laser beam that is emitted from the semiconductor laser to an optical recording disk;
an objective lens for converging the laser beam that is deflected by the raising mirror on the optical recording disk;
a signal detection light receiving element for detecting a return light beam from the optical recording disk;
an optical path splitting element for separating an optical path directed to the optical recording disk from the semiconductor laser from an optical path directed to the signal detection light receiving element from the optical recording disk; and
a monitor light receiving element for monitoring the laser beam to control an output of the semiconductor laser, where the monitor light receiving element is disposed behind the raising mirror to receive a light beam of an end part in a major axis direction of a far field pattern of the laser beam that leaks over an edge side of the raising mirror.

8. The optical head device according to claim 1, wherein a major axis of an elliptical shaped optical spot that is converged on the optical recording disk is obliquely oriented with respect to both a radial direction of the optical recording disk and a tangential direction of a track of the optical recording disk.
